(19) United States
(12) Patent Application Publication
(10) Pub. No.: US 2012/0203666 A1
(43) Pub. Date: Aug. 9, 2012

(54) CONTACTLESS WIRELESS TRANSACTION PROCESSING SYSTEM

(75) Inventors: Arthur Torossian, Glendale, CA (US); David Maxwell, Los Angeles, CA (US)

(73) Assignee: TYCOON UNLIMITED, INC., Vernon, CA (US)

(21) Appl. No.: 13/090,191

(22) Filed: Apr. 19, 2011

Related U.S. Application Data
(63) Continuation-in-part of application No. 13/024,276, filed on Feb. 9, 2011.

(51) Int. Cl. G06Q 30/00

(52) U.S. Cl. 705/26.41

(57) ABSTRACT

A wireless transaction processing system that includes a seller associated with a transaction data, and a buyer having an Internet enabled device that can access an account associated with the wireless transaction processing system. The wireless transaction processing system, through the Internet enabled device of the buyer enables full processing of transactions without the use of physical cards.

### CROSS-REFERENCE TO RELATED APPLICATIONS

This is a Continuation-In-Part application claiming the benefit of priority of the co-pending U.S. Utility Non-Provisional patent application Ser. No. 13/024,276, with a filing date of Feb. 9, 2011, the entire disclosures of which application is expressly incorporated by reference in its entirety herein.

### BACKGROUND OF THE INVENTION

1. Field of the Invention

This invention relates to wireless transaction processing system and, more particularly, to contactless transaction processing system using wireless mobile Internet devices.

2. Description of Related Art

Conventional wireless transaction or payment processing systems using wireless devices (such as handheld devices) have been known for a number of years. Most of the conventional wireless transaction or payment-processing systems using wireless devices are vendor-centric. That is, the entire system is designed and implemented with the view that the retailer is the “hub” or the focal point of the payment processing systems for transactions, and most (if not all) functionality to access the conventional wireless transaction or payment-processing systems is initiated by the merchant or the vendor.

Most vendor or merchant-centric systems are based on a retail business-model, which requires a retailer or merchant and a consumer with at least one card account (credit cards, debit cards, etc.). Conventional systems that are used in a retail environment suffer from obvious disadvantages in that they require the retailers or merchants to obtain additional, dedicated specialty wireless hardware or equipment to perform or execute wireless transaction or payment processing. Further, most of the retail or merchant dedicated hardware used for execution of wireless transactions require custom configuration and installation, which further add to the overall cost of providing wireless transaction processing service at the retail or merchant establishment.

Other obvious disadvantages of the conventional wireless transaction or payment processing systems using wireless devices is that they require wireless communication between the handheld device and the dedicated, specialty wireless hardware or equipment at the retail or merchant location. In most cases, wireless communication between any two entities introduces the possibility of interception (by a third party) of that which is wirelessly communicated between the two entities (e.g., the wireless handheld device and the dedicated wireless hardware at the retail or merchant location). With conventional systems, the communication between the handheld device and the merchant specialty equipment include confidential personal information, which further jeopardizes the overall identity and security of the users. Further, the mobile Internet devices must some how be configured to sync and function or work with the specialty equipment, which makes the mobile Internet device even more vulnerable to identify theft. Additionally, conventional systems developed (e.g., Near Field Communication—NFC) require specialized hardware to be installed either onto or within the wireless device (e.g., mobile phone) for full implementation of conventional wireless transaction or payment processing systems. Still other disadvantages of some conventional wireless transaction processing systems is that they aim to eliminate the use of encryption technology, which further enhances interception of wireless exchange of information between two entities by a third party.

Finally, the merchant or vendor-centric systems or retail business-models mentioned above do not accommodate entity-to-entity direct transactions where both entities are non-retailers or non-merchants (e.g., both entities may, for example, be individual persons).

Accordingly, in light of the current state of the art and the drawbacks to current wireless transaction processing systems mentioned above, a need exists for wireless transaction processing system that would be consumer-centric where the entities such as retailers or consumers (e.g., the mobile devices used) are not required to obtain additional, dedicated specialty wireless hardware or equipment to perform or execute wireless transaction or payment processing. Further, even if such transactions are accomplished wirelessly using additional wireless equipment, no personal or private confidential information is exchanged. Additionally, a need exists for a consumer-centric wireless transaction processing system where information exchanged is encrypted for security. Furthermore, a need exists for a consumer-centric wireless transaction processing system that would enable personal, direct transactions between individuals without requiring credit cards, involvement of retailers or merchants, or the involvement of fund transferring institutions. Finally, a need exists for integration of most types of transactions, including, but not limited to, most cashless transactions, payment, purchasing, and direct fund transfer between entities within a single system accessed by an Internet enabled mobile device.

### BRIEF SUMMARY OF THE INVENTION

An exemplary optional aspect of the present invention provides a contactless wireless transaction processing system, comprising:
one or more servers that provide a hub for communications and cashless transactions between diverse entities;
a buyer having a mobile Internet device, with both the buyer and the mobile Internet device of the buyer associated with the contactless wireless transaction processing system;
a seller that generates a transaction data when the buyer uses goods or services of the seller, with the transaction data having no information considered confidential;
the mobile Internet device of the buyer receives and transmits the transaction data with GPS information of both the buyer and the seller to the contactless wireless transaction processing system for validation of buyer, seller, and transaction data;
with one of contactless wireless transaction processing system and a third party authorizing the transaction after validation by the contactless wireless transaction processing system; and
with the seller account credited and the buyer account debited in accordance with the transaction data.

Another exemplary optional aspect of the present invention provides a transaction system, comprising:
an integrated contactless wireless transaction processing system that is integrated with a credit issuing entity;
a buyer having a mobile Internet device, with both the buyer and the mobile Internet device of the buyer associated with the integrated contactless wireless transaction processing system of the credit issuing entity;
a seller that generates a transaction data when the buyer uses goods or services of the seller, with the transaction data having no information considered confidential;
the mobile Internet device of the buyer receives and transmits the transaction data with GPS information of both the buyer and the seller to the integrated contactless wireless transaction processing system of the credit issuing entity for validation of buyer, seller, and transaction data;
with the credit issuing entity authorizing the transaction after validation by the integrated contactless wireless transaction processing system of the credit issuing entity;
wherein the authorization is communicated with a merchant service provider of the seller, with the seller account credited and the buyer account debited in accordance with the transaction data.

Still another exemplary optional aspect of the present invention provides a transaction system, wherein:
the association of the buyer with the integrated contactless wireless transaction processing system of the credit issuing entity commences when the buyer establishes an account with the credit issuing entity.

Yet another exemplary optional aspect of the present invention provides a transaction system, wherein:
after the association, a branded integrated contactless wireless transaction processing system of the credit issuing entity is downloaded as a branded mobile application to the mobile Internet device of the buyer, enabling buyer to communicate and access the associated account.

Another exemplary optional aspect of the present invention provides a computer program product for wireless transaction processing system for purchasing, the computer program product comprising a computer-readable medium having computer program instructions stored therein for causing one or more computers to perform operations of:
receiving and transmitting a transaction data with GPS information of both a buyer and a seller to an integrated contactless wireless transaction processing system of a credit issuing entity for validation of buyer, seller, and transaction data;
the credit issuing entity authorizing the transaction after validation by the integrated contactless wireless transaction processing system of the credit issuing entity;
wherein the authorization is communicated with a merchant service provider of the seller, with the seller account credited and the buyer account debited in accordance with the transaction data.

Such stated advantages of the invention are only examples and should not be construed as limiting the present invention. These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

Referring to the drawings in which like reference character(s) present corresponding part(s) throughout:

FIG. 1A is an exemplary system overview of the wireless transaction processing system in accordance with the present invention;

FIG. 1B is an exemplary illustration of an online registration scheme of a wireless transaction processing system in accordance with the present invention for seller and buyer memberships;

FIG. 1C is an exemplary illustration of a set of information accessed by a user after login to the personal wireless transaction processing system account;

FIG. 1D is an exemplary illustration of computer system(s) of a wireless transaction processing system platform in accordance with the present invention;

FIG. 1E is an exemplary illustration of a well-known, conventional mobile Internet device that may be used with the wireless transaction processing system in accordance with the present invention;

FIG. 1F is an exemplary detailed system overview of the wireless transaction processing system within the context of an overall credit/debit card transaction system in accordance with the present invention;

FIGS. 2A to 2L are exemplary flowchart illustrations of the wireless transaction processing system in accordance with the present invention;

FIGS. 3A to 3D are exemplary flowcharts illustrating a process of transfer of funds from one individual or entity to another individual or entity using the wireless transaction processing system in accordance with the present invention;

FIG. 4A is an exemplary system overview of the wireless transaction processing system integrated within existing credit/debit transaction system in accordance with the present invention; and

FIGS. 4B to 4D are exemplary flowchart illustrations of the details of the wireless transaction processing system integrated within a credit issuing entity in accordance with the present invention.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

For purposes of illustration, programs and other executable program components are illustrated herein as discrete blocks, although it is recognized that such programs and components may reside at various times in different storage components, and are executed by the data processor(s) of the computers. Further, each block within a flowchart may represent both method function(s), operation(s), or act(s) and one or more elements for performing the method function(s), operation(s), or act(s). Each block may comprise of one or more protocol(s) for execution of one or more function(s), operation(s), or act(s). In addition, depending upon the implementation, the corresponding one or more elements may be configured in hardware, software, firmware, or combinations thereof.

This disclosure defines a seller as one or more entity that promotes, exchanges, or sells goods and or services for money. Non-limiting examples of a seller may include, for example, a vendor, retailer, merchant, wholesaler, dealer, professional entities such as accountants, attorneys, etc. This disclosure defines a buyer as one or more entity that makes a purchase. Non-limiting examples of a buyer may include, for example, a purchaser, consumer, etc. It should further be noted that a purchasing environment may generally be defined as one where any expenditure of funds or money is exchanged for goods and services. Finally, a seller may have a physically existing real world “brick-and-mortar” location or presence, or, alternatively, a seller may solely have an online or virtual presence. It should further be noted that there are instances where a seller may have both an online and a physically existing presence. For example, a bookstore may have both an online presence, and also have a physically existing presence in a physically existing geographic location such as in a city.

The present invention provides a consumer-centric contactless transaction processing system using wireless mobile Internet devices. The consumer-centric contactless transaction processing system of the present invention using wireless mobile Internet devices obviates the mandatory requirement for the entities such as retailers to obtain additional, dedicated specialty wireless hardware or equipment to perform or execute wireless transaction or payment processing. Further, even if such transactions are done wirelessly using specialty equipment, no personal or private confidential information is exchanged when using the wireless transaction processing system of the present invention. Additionally, the consumer-centric contactless wireless transaction processing system of the present invention exchanges information using encryption and other well-known methodologies for security. Furthermore, the wireless transaction processing system of the present invention enables personal, direct transactions between individuals without requiring credit cards, involvement of retailers or merchants, or the involvement of fund transferring institutions. Finally, contactless transaction processing system using wireless mobile Internet devices of the present invention integrates most types of transactions, including, but not limited to, cashless transactions, payment, purchasing, and direct fund transfer between entities within a single system accessed by a mobile device.

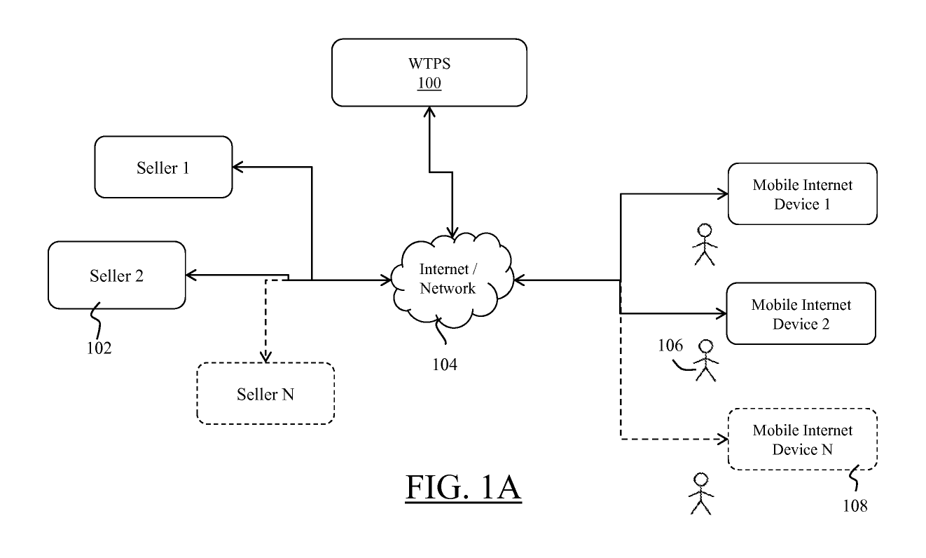

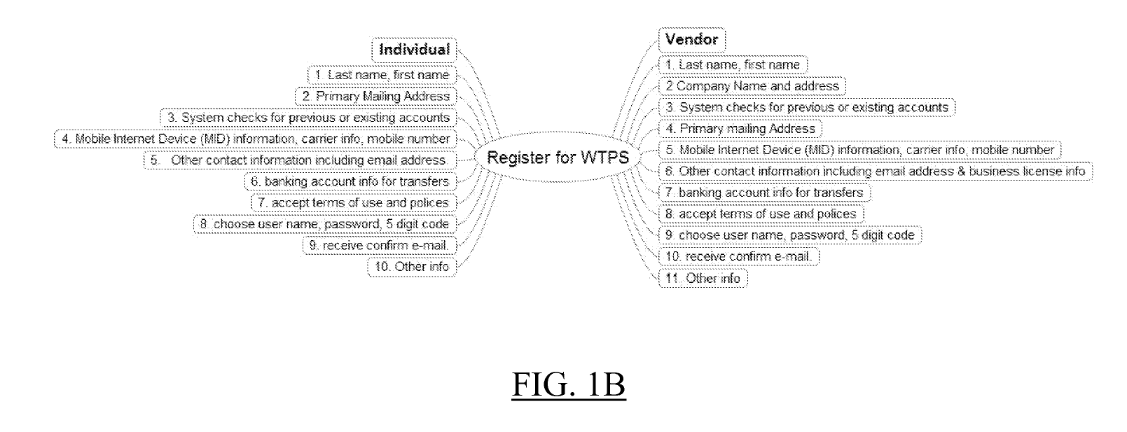

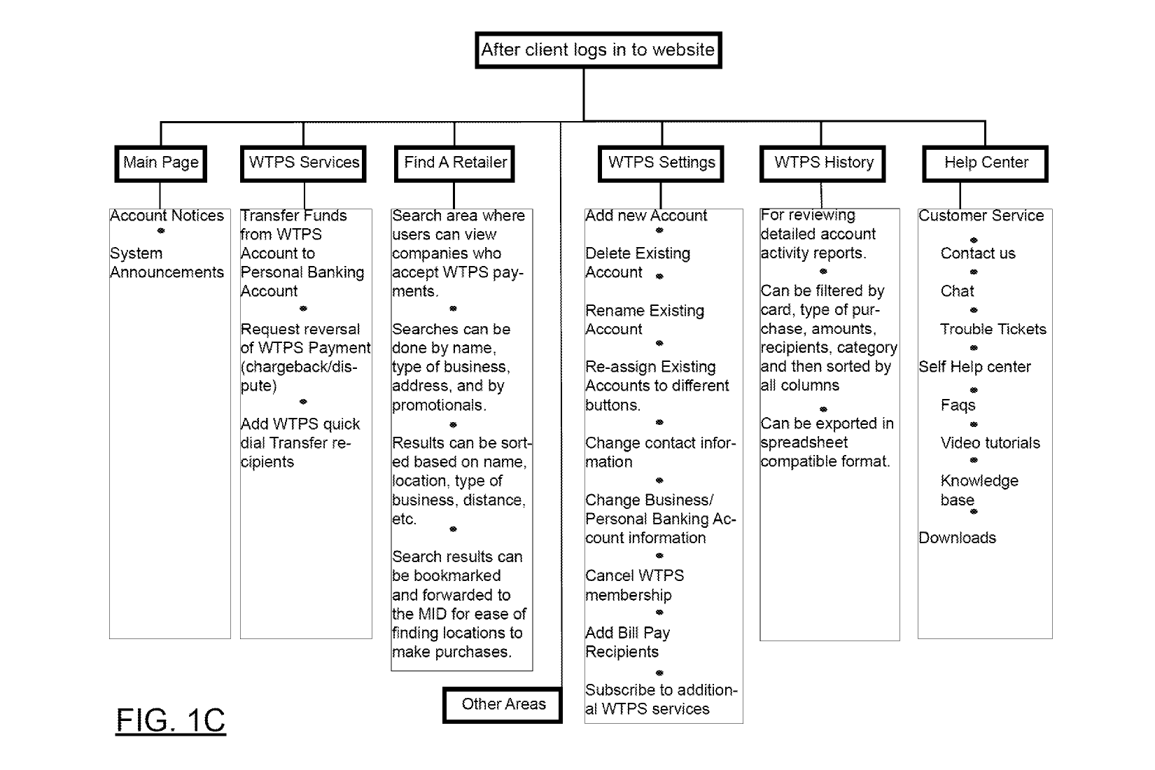

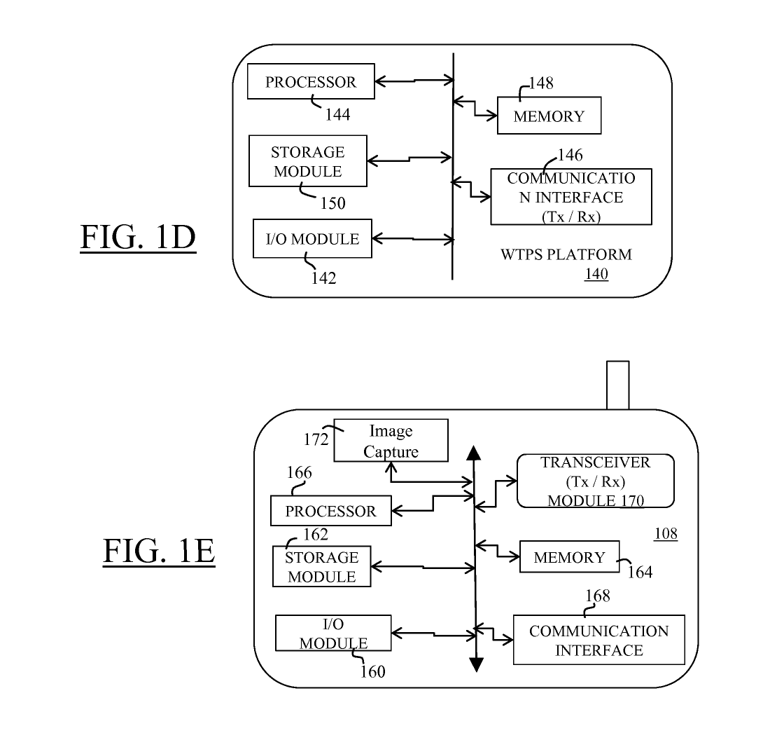

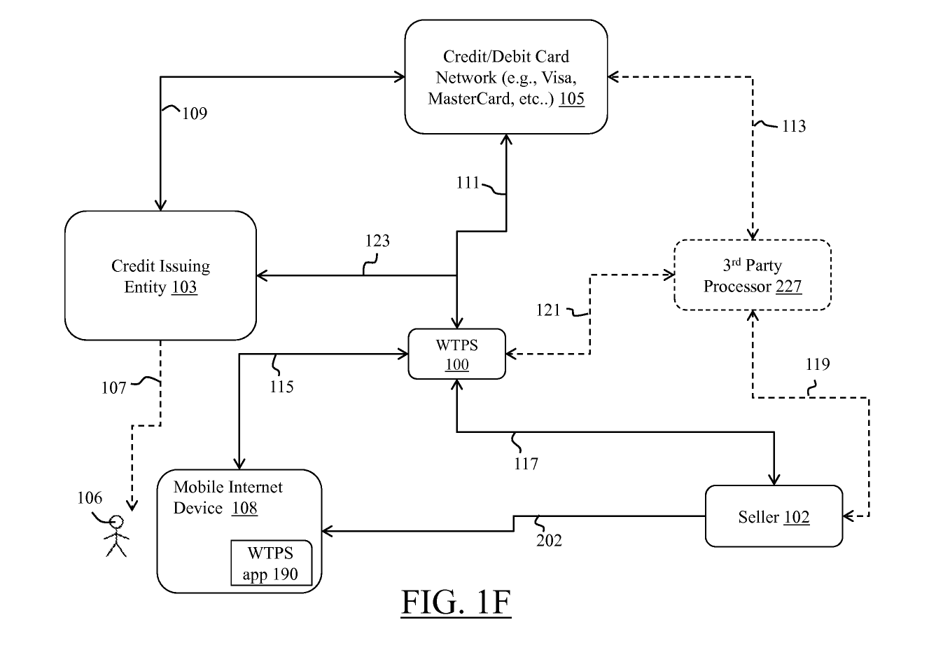

FIG. 1A is an exemplary system overview of the wireless transaction processing system in accordance with the present invention. As illustrated, the consumer-centric contactless wireless transaction processing systems (hereinafter referred to as “WTPS”) 100 of the present invention includes one or more seller 102 that is associated with the WTPS 100, and communicatively associated therewith via Internet or a network 104. In this exemplary instance, the seller 102 is a seller that is a registered member of the WTPS 100, and may (for example) be a neighborhood convenient store.

As further illustrated, the WTPS 100 of the present invention includes one or more buyer 106 that is associated with the WTPS 100, and communicatively associated therewith via Internet or a network 104 using a mobile Internet device 108. In this exemplary instance, the buyer 106 is a registered member of the WTPS 100, with the buyer having at least one Internet enabled device 108 that can access the WTPS 100 via the Internet or network 104.

As a non-limiting example, with the WTPS 100 of the present invention, a buyer 106 that is a member of the WTPS 100 may walk into a convenient store 102 that is also a member of the WTPS 100 without carrying any cash or credit cards, purchase the desired goods and services of the seller 102, and complete a transaction for purchase of the goods and services using the mobile Internet enabled device 108. The seller 102 is not required to have any specialty equipment, and no confidential information is exchanged between the seller 102 and the member buyer 106.

As yet another non-limiting example, with the WTPS 100 of the present invention, a first individual member may directly transfer funds to a second individual member anywhere at anytime for immediate use by the second individual member using the mobile Internet device 108, and without accessing their respective bank accounts, or requirement of any specialty equipment.

FIG. 1B is an exemplary illustration of an online registration scheme of a wireless transaction processing system in accordance with the present invention for seller 102 and buyer 106 memberships. As with most conventional online registration schemes, seller 102 and buyer 106 may access the online registration site of the wireless transaction processing system website to create an account and register with the WTPS 100. The required information and processing for creation of an account and registration is similar to known processes that create conventional online bank accounts with most commercial banks. It should be noted that after a buyer becomes a registered member of the wireless transaction processing system, a mobile app (or a mobile application) of the WTPS 100 is automatically downloaded to the mobile Internet device 108 (such as a mobile phone) of the buyer 106, where the buyer 106 can associate and communicate with the WTPS 100. On the other hand, after a seller 102 becomes a registered member of the WTPS 100, the seller 102 can associate and communicate with the WTPS 100 at the physical location of the seller 102 by a variety of means, including a seller mobile device (associated with the system 100 during registration), specialty equipment (if desired), or simple mobile phone (associated with the WTPS 100 during registration).

At a minimum, the WTPS 100 registration system requires seller and buyer identification information, non-limiting, non-exhaustive list of examples of which are exemplarily illustrated in FIG. 1B, including device-ID for their respective mobile Internet devices, business information of the seller, and so on.

FIG. 1C is an exemplary illustration of a set of information accessed by a user after login to the personal wireless transaction processing system account. As with most conventional online banking account schemes, a user (seller 102, buyer 106, administer, or other authorized entities) may access their online account after login through any Internet enabled device. A WTPS 100 user account (e.g., buyer or seller) includes typical information about user balances, and other typical, well-known tools illustrated in FIG. 1C such as account settings, history, help center, other services, and so on, the creation and uses of which are very well-known and similar to most online banking websites. Non-limiting, non-exhaustive list of examples of tools and information available in a WTPS user account are exemplarily illustrated in FIG. 1C, including association of personal accounts (such as credit, debit, checking, saving, investments, or other accounts) with the WTPS, and assignment of the associated account with a graphic user interface (GUI) for use, such as a soft button.

FIG. 1D is an exemplary illustration of computer system(s) of a wireless transaction processing system platform in accordance with the present invention. The computer system(s) of the wireless transaction processing system platform 140 may comprise of one or more computers or servers in one or more locations. As illustrated in FIG. 1D, the platform 140 is comprised of an input and output (I/O) module 142 for receiving information and or data from various entities, including, but not limited to various admin users, mobile Internet devices, sellers, buyers, or others, including any inputting mechanism, such as a communication module, an external computer connected to the platform, a network and or Internet connection, or any computer readable medium such as a floppy disk, Compact Disk (CD), a Digital Versatile Disk/Digital Video Disk (DVD), and a removable hard drive. The I/O module 142 may also be configured for receiving user input from another input device such as keyboard, a mouse, or any other input device best suited for the current environment conditions. Note that the I/O module 142 may include multiple “ports” for receiving data and user input, and may also be configured to receive information from remote databases or computer or servers using wired or wireless connections. The I/O module 142 is connected with the processor 144 for providing output to various entities, possibly through a video display. Output may also be provided to other devices or other programs, e.g. to other software modules, for use therein, possibly serving as a wired or wireless gateway to external databases or other processing devices such as mobile Internet devices 108. Further included is communication interface 146, which may include a wireless or wired transceiver Tx/Rx for implementing desired communications protocols. The processor 144 is coupled with a memory 148 to permit software such as control information to be manipulated by commands to the processor 144, and storage module 150 for storage of data.

FIG. 1E is an exemplary illustration of a well-known, conventional mobile Internet device that may be used with the wireless transaction processing system in accordance with the present invention. As illustrated, the mobile Internet device 108 is any well-known conventional mobile Internet device, including netbooks, notebooks, laptops, mobile phones, or any other device that is Internet enabled. The mobile Internet device 108 includes the typical, conventional components such as an I/O module 160 (e.g., a display, etc.), a storage module 162 for storing information, a memory 164 used by a processor 166 to execute programs, a communication interface 168 for implementing desired communication protocol, a transceiver module 170 for transmitting and receiving data, and an image capture device such as a camera 172. The mobile internet device 108 uses the wireless transaction processing system mobile application to communicate with the WTPS 100 in order to process transactions.

FIG. 1F is an exemplary detailed system overview of the wireless transaction processing system within the context of an overall credit/debit card transaction system in accordance with the present invention. The Internet/Network 104 shown in FIG. 1A is removed from the illustration in FIG. 1F for simplicity and ease of illustration to avoid clutter, and for better understanding. However, it is readily apparent and should be obvious to those skilled in the art that wireless communication by entities involved are in general through the Internet/Network 104. Therefore, the non-limiting, exemplary illustration of arrows that directly or indirectly connect any one or more entities with any other one or more entities is merely illustrative for ease of understand, and it is understood that such connectivity is wireless and may be through the Internet/Network 104.

As illustrated in FIG. 1F, the present invention provides for secure processing of non-physical monetary transactions, such as credit card and debit card transactions, utilizing coded data transmitted via mobile internet device 108 rather than the use and handling of physical plastic credit/debit account cards. The WTPS platform 140 utilization consists of a separate outside service (or one or more server) provider serving as a “central” platform or “hub” for all communications and approvals. As stated above, the computer system(s) of the wireless transaction processing system platform 140 may comprise of one or more computers or servers in one or more locations. Accordingly, the term “central” or “hub” should not be construed as a single location or a single server, but may be defined as a center of activity, functionality, commerce, or transactions.

The WTPS 100 provides an independent “hub” for transactions and communications between many diverse entities. Accordingly, the WTPS 100 illustrated in FIG. 1F is independent of all entities and is non-specific to any, including any seller 102 and buyer 106. The WTPS 100 may be associated (as an independent, autonomous, separate, self-contained, non-integral entity within) a financial institution such as a credit issuing entity, credit network, or a merchant service provider, but without being a sole, integral part of that entity. Maintaining the independence of WTPS 100 while associated with a financial institution enables the processing of any transaction for any account of any member buyer and member seller. For example, a buyer may have banking relationship with a first bank, a seller may have a banking relationship with a second bank, the third party processor may be a third bank, and the WTPS 100 may be associated with a fourth bank. In this instance, a member buyer 106 and a member seller 102 of the WTPS 100 may seamlessly execute full transactions, regardless of associations.

In the exemplary embodiment illustrated in FIG. 1F, the WTPS 100 can handle all cashless transactions (e.g., transactions using credit/debit cards) in a contactless manner. The WTPS 100 eliminates the use of all other third party processors 227 and instead relies on its own internal processing to handle such transactions. However, as illustrated in FIG. 1F, the WTPS 100 may also optionally have association with individual third party processors 227, which can facilitate cashless transactions.

The overall credit/debit card transaction system includes at least one credit issuing entity 103 that issues credit/debit cards to consumers and businesses. It should be noted that it is only for clarity and convenience of example that a single box is used to illustrate one or more credit issuing entities. A non-limiting example of credit issuing entity may include a bank that issues credit card or a debit card to bank customers, including consumer and business customers. The credit/debit card network 105 is network of credit/debit card companies. Non-limiting examples of companies that constitute the credit/debit card network may include Visa®, MasterCard®, and so on. A third party processor 227 is an entity that is established to store, process, or transmit credit/debit transactions for merchants, which may include approval/denial of transactions. A non-limiting example of a third party processor 227 may be a merchant bank that functions as a merchant service provider (e.g., providing a merchant account to seller 102 for enabling the seller 102 to accept card-based transactions). It should be noted that the credit issuing entity 103 and the third party processor 227 may be two separate divisions or departments of the same institution such as a bank or may be two separate institutions. For example, the credit issuing entity 103 may be a bank that issues a credit card to a consumer, and when the card is used by the consumer to purchase a product, a different division of the same issuing bank may act as a third party processor to deny the transaction, which means that the transaction was not approved by the card issuer.

When the credit issuing entity 103 issues credit (e.g., via a credit card account) to a buyer 106 (as illustrated by the communication 107), the amount of credit issued and available (the available balance) to the buyer 106 is reported to the credit/debit card network 105 (indicated via communication 109). As stated above, after a buyer 106 becomes a registered member of the WTPS 100, a mobile app (or a mobile application) of the wireless transaction processing system is downloaded to the mobile Internet device 108 (such as a mobile phone) of the buyer 106, where the buyer 106 and the mobile Internet device 108 are associated and enabled to communicate via 115 with the WTPS 100. The registration with the WTPS 100 enables the buyer 106 to associate any issued credit accounts from any one or more credit issuing entities 103 via communication 123 with the WTPS account of the buyer 106. The wireless transaction processing system application for the mobile device (hereinafter referred to as “WTPS app”) may be launched via the mobile Internet device 108 to enable a user (e.g., buyer 106) access to the WTPS user account. As illustrated, the buyer 106 may select the desired items from the exemplary convenience store or seller 102 for purchase (e.g., a bag of groceries), with the seller 102 generating a transaction data 202 (detailed below) for the buyer 106 for the selected goods and or services.

When a buyer 106 makes a purchase from the seller 102 using the mobile Internet device 108, that information is communicated via 115 to the WTPS 100, which, in turn, may optionally communicate the information via communication 121 to the optional third party processor 227. Regardless, either WTPS 100 or the third party processor 227 forward a request (indicated by communication 111/113) to the credit/debit card network 105 regarding the purchase amount, and the credit/debit card network 105 determines the balance of credited amount available for use by the buyer 106, and reports back to the WTPS 100 (or optionally, the third party processor 227) via communication 111/113. Thereafter, based upon the availability of credit, the transaction is either approved or denied by WTPS 100 (or optionally, the third party processor 227), with results reported (via communications 115 and 117) from the WTPS 100 to the buyer 106 and or seller 102 or to seller 102 via communication 119 by the third party processor 227. It should be noted that WTPS 100 may handle all reporting. That is, instead of the third party processor 227 reporting the authorization results directly to the seller 102 via communication 119 that the buyer 106 is approved (or denied credit), the third party processor 227 may instead handle all work and simply report the authorization results to the WTPS 100 via communication 121 for distribution by WTPS 100 via communications 115 and 117 to respective buyer 106 and seller 102. After the transaction is complete, the credit account of the buyer 106 is debited by the purchase amount and the account of the seller 102 is credited by the same amount, and the respective accounts of the buyer 106 and seller 102 are updated in all entities involved in the transaction.

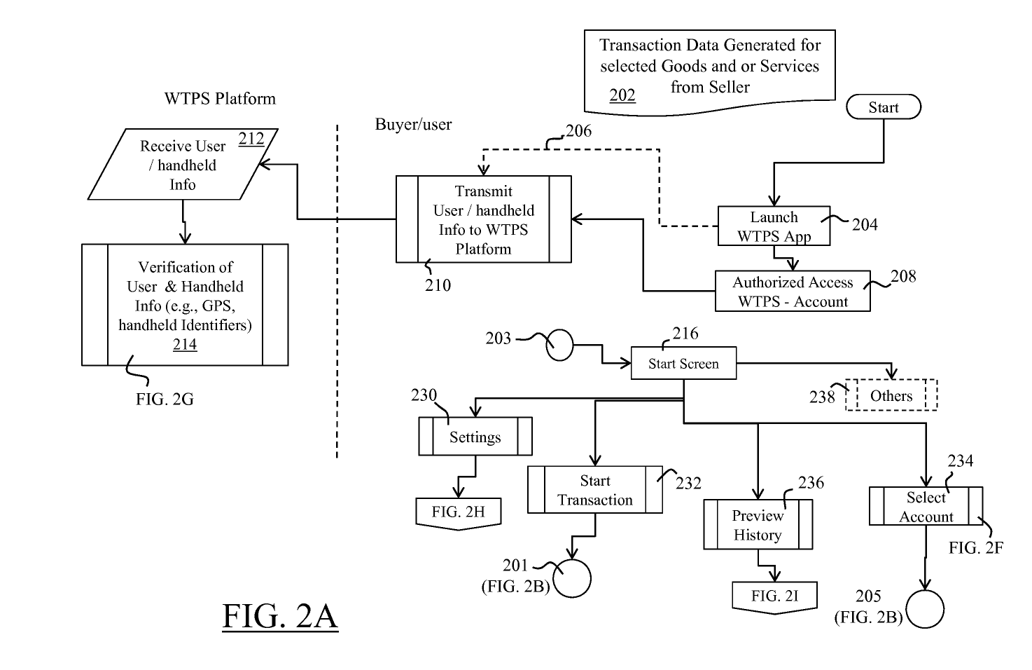

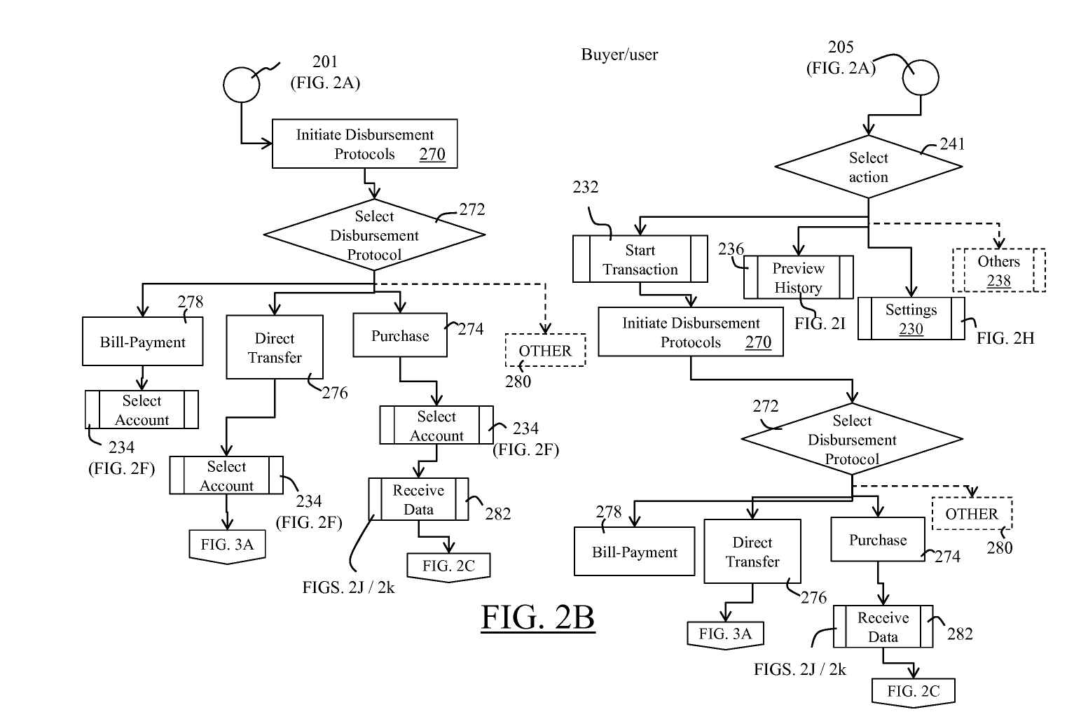

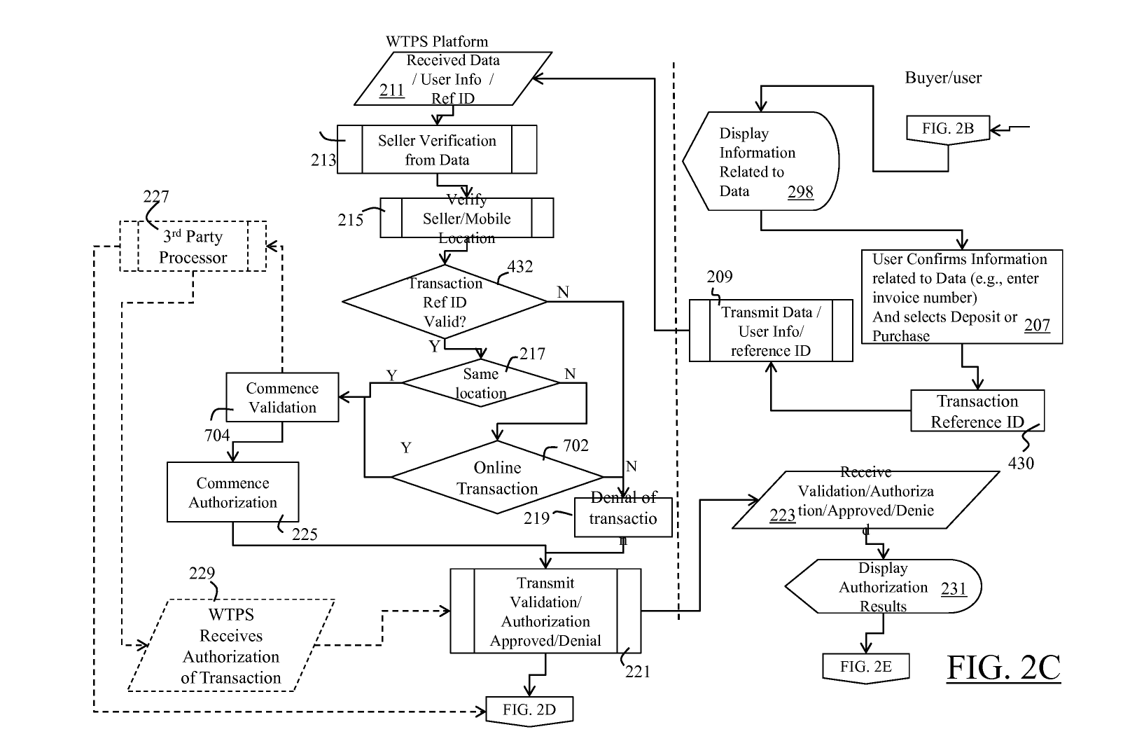

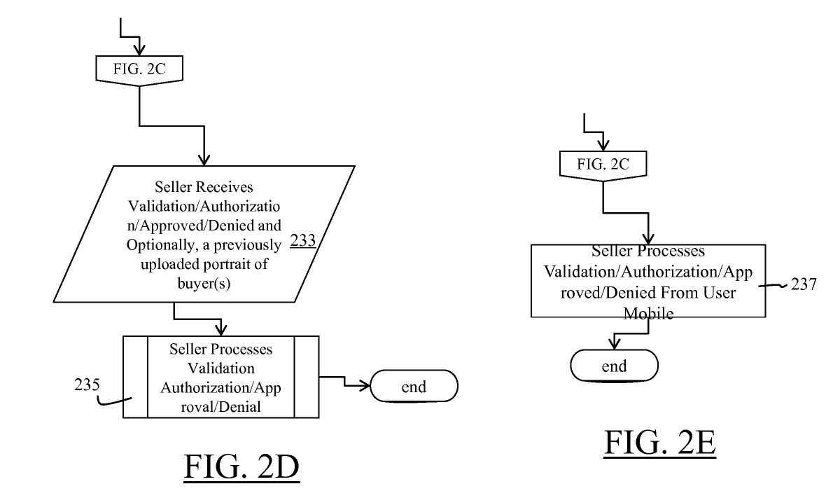

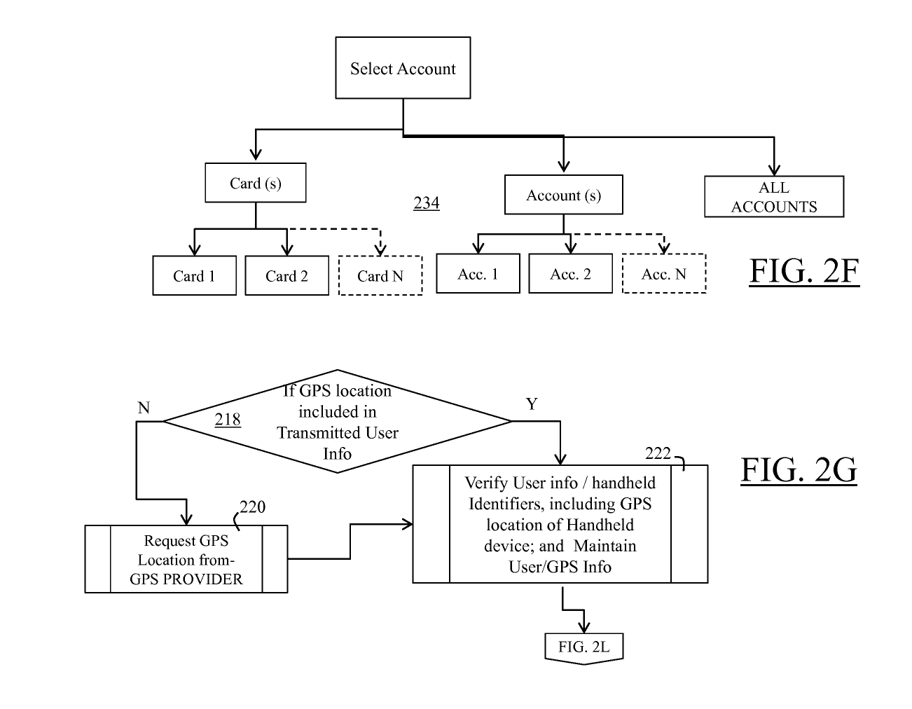

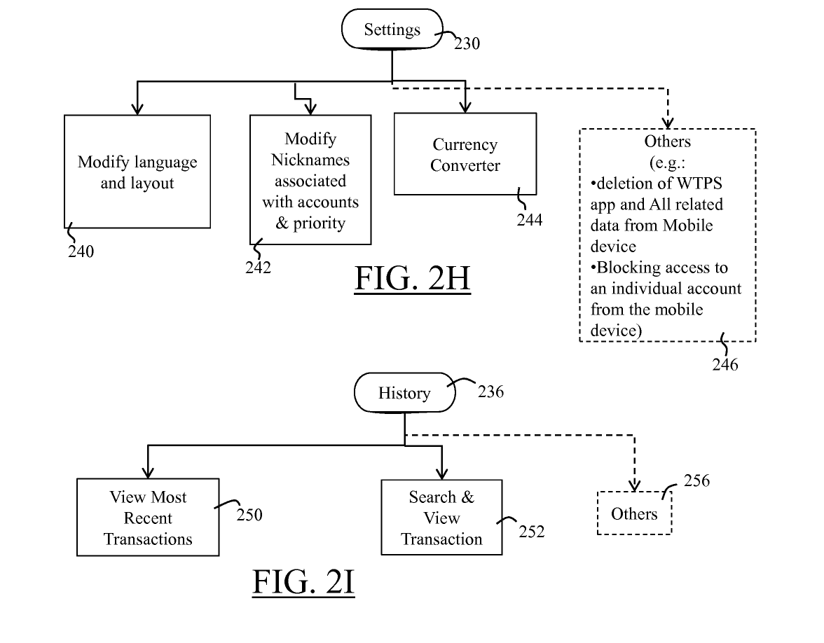

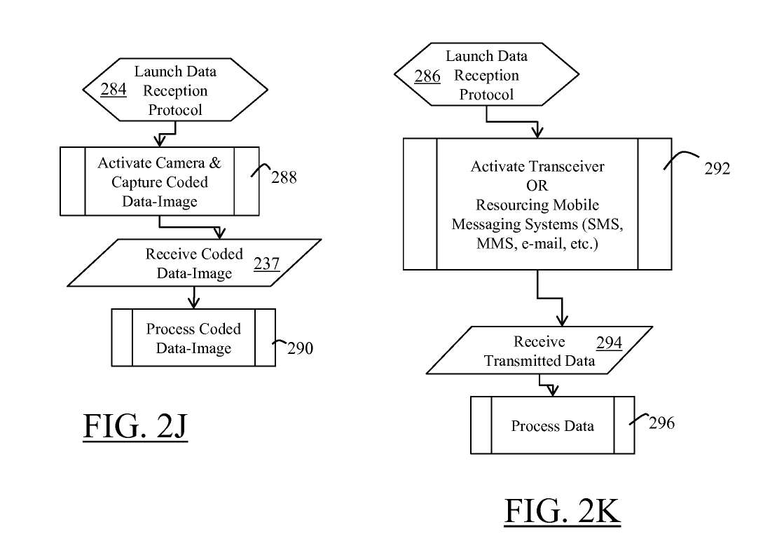

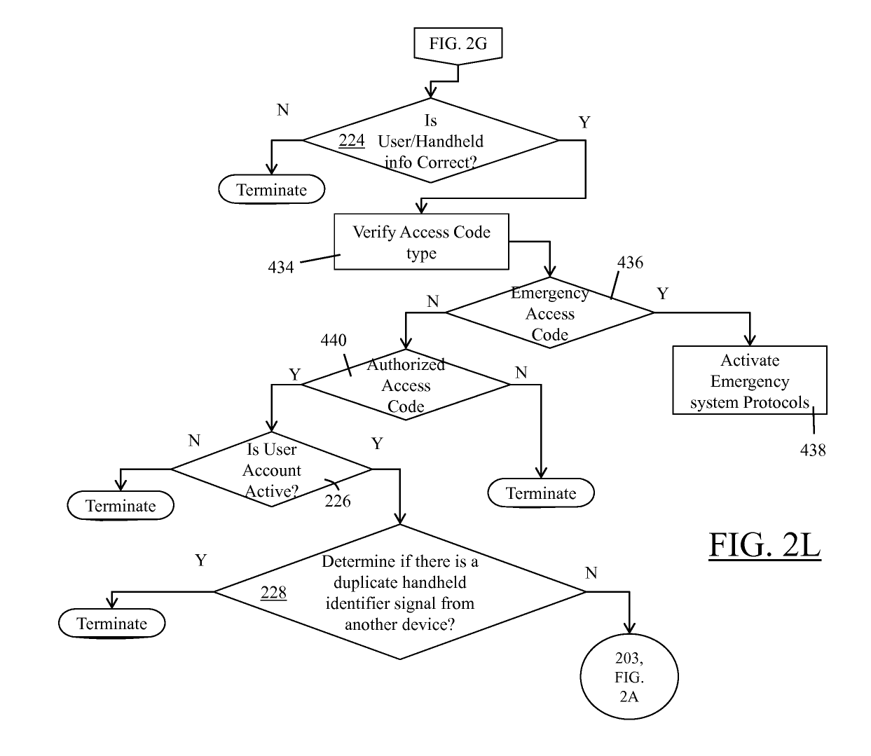

FIGS. 2A to 2L are exemplary flowchart illustrations of the details of the contactless wireless transaction processing system in accordance with the present invention. As illustrated in FIG. 2A, with the WTPS 100 of the present invention, a buyer 106 that is a member of the WTPS 100 may walk into a convenient store 102 that is also a member of the WTPS 100 without carrying any cash or credit cards, purchase the desired goods and services of the seller 102, and complete a transaction for purchase of the goods and services using the mobile Internet enabled device 108. The seller 102 is not required to have any specialized equipment, and no confidential information is exchanged between the seller 102 and the member buyer 106. The buyer 106 may select the desired items from the exemplary convenient store 102 for purchase (e.g., a bag of groceries), with the seller 102 generating a transaction data 202 (detailed below) for the buyer 106 for the selected goods and or services.

As further illustrated in FIG. 2A, in order to commence transaction using the WTPS 100 of the present invention, the buyer 106 must launch the WTPS app 190 using the mobile Internet device 108 (operational functional act 204). The launching operation 204 of the WTPS app 190 from the mobile Internet device 108 may immediately transmit location information 206 (via a typical GPS system) of the mobile Internet device 108 to the WTPS platform 140 through the operational functional act 210, and initiates an access protocol 208. Alternatively, the launch operation 204 of the WTPS app 190 may simply initiate the access protocol 208 only, without an immediate transmission of location information 206 prior to authorized access. After the launch operation 204 of the WTPS app 190, the access protocol 208 using a graphic user interface (GUI) enables the authorized user to enter appropriate authorization code such as a password to allow access to the WTPS user account. It should be noted that WTPS 100 may provide users with may different types of access codes. Non-limiting examples of which may include a user generated password that may enable a user to fully access all features of WTPS user account, an access code for limited access to WTPS user account (for example, to enable view of history of transactions only), or an access code that would activate emergency system protocols (e.g., the user is forced (by thief) to access the WTPS account to transfer funds).

Assuming an access code is entered, the access protocol 208, through the operational functional act 210 provides the WTPS platform 140 with the consumer or buyer 106 identification information (buyer-ID) and buyer physical location via a typical GPS system. The WTPS platform 140 received that information via the operational functional act 212, and upon verification via the operational functional act 214 approves access to the WTPS app 190 to launch a main screen or main page at the operational functional act 216 on the I/O module 160 of the mobile Internet device 108.

As illustrated in FIGS. 2A, 2G, and 2L, the verification operational functional act 214 to verify user 106 and the mobile Internet device 108 (e.g., a handheld device information) by the WTPS 100 includes the operational functional act 218, which, as illustrated in FIG. 2G, includes determining if the GPS location of the mobile Internet device 108 has been included in the transmitted information via the operational functional act 210. If the WTPS 100 determines that the GPS location is not included in the transmission operational functional act 210, the WTPS 100 requests GPS location from a GPS provider via the operational functional act 220. Otherwise, if the WTPS 100 determines that the GPS location is included, the system 100 verifies user and handheld (e.g., device 108) information, including location of the device 108 via the operational functional act 222.

As detailed in the exemplary flowchart of FIG. 2L, the verification process of the operational functional act 214 includes the operational functional act 224, which determines if the device 108 information (device signal-ID) is correct, and if so, it verifies the access code type at the operational functional act 434. If the WTPS determines at the operational functional act 436 that the access code type is an emergency access code, the WTS 100 activates emergency system protocols at the operational functional act 438, which may include a variety of functions non-limiting, non-exhaustive examples of which may include completing the transaction for the safety of the user (or zeroing all account balances listed on the WTPS app 190 of the mobile Internet device) and automatically notifying proper authorities with respect to the location of the user (e.g., transmit request for emergency assistance to the location of the user).

If the WTPS 100 determines that the access code is not an emergency access code, then WTPS 100 determines if the access code is an authorized access code at the operational functional act 440. If it is determined that the access code is an authorization access code, then the WTPS 100 determines if WTPS user account is active (at the operational functional act 226), for example, has the account be canceled, mobile Internet device reported as stolen or lost, and so on. The determinations in the operational functional acts 224 and 226 may be accomplished by numerous methods, a non-limiting example of which may including the use of relational data base systems that easily compare the stored registration information of users (e.g., sellers and buyers) and their device information with incoming information via the operational functional act 210 (FIG. 2A).

As further illustrate in FIG. 2L, the WTPS 100 also determines if there is a duplicate device identifier signal from another device at the operational functional act 228. A duplicate device identifier signal may be generated, for example, by cloning a mobile Internet device. For example, a first user with original mobile Internet device in location “A” may request access to WTPS 100 at a first time interval, while a second user with a duplicate identifier signal (e.g., using a clone mobile Internet device) may request access to the WTPS 100 in location “B” simultaneously or at a subsequent second time period. This creates conflict in location (known as “location hopping”) of the mobile Internet device because a physical object cannot exist in two places at substantially short time frame. That is, the WTPS 100 “sees” the same phone (due to identical device signal identifiers) in two different geographic locations “A” and “B” within a short time frame. In such an instance, the operational functional act 228 based on the duplicate device signal identifier from two locations “A” and “B” will prevent both the first and the second users from accessing the WTPS 100 by terminating all further processing for both devices. This prevents a would be thief from stealing a device identifier signal (device signal-ID) of an original mobile Internet device and using that original device signal-ID to access WTPS 100 by a cloned version to access another persons WTPS user account to commence unauthorized transaction. It should be noted that the use of GPS or similar location identifier systems to access and use the WTPS 100 of the present invention is also used to verify that the consumer was at a particular location for purchase of goods and services from a seller.

Referring back to FIG. 2A, after authorized access by the buyer 106, the WTPS app within the mobile Internet device 108 displays the main page or start screen through the operational functional act 216 (via connector 203 in FIGS. 2L and 2A) where the user 106 may perform a variety of functions. Non-limiting examples of functions enabled may include modifying settings of the WTPS user account through the operational functional act 230, start of a transaction (operational function act 232), preview of account history (operational functional act 236), selecting an account associated with the WTPS user accounts (operational functional act 234) to perform a variety of functions associated with the selected account, or performance of other functions (operational functional act 238).

The present invention provides capabilities that enable a user to access the above-mentioned functionalities in a variety of manner. As illustrated in FIGS. 2A and 2B, the user may first select a specific account via the select account operational act 234 of FIG. 2A, and then select an action 241 of FIG. 2B (via the connector 205 between FIGS. 2A and 2B) to perform a function on that particularly selected account. For example, a user may first select an account via the operational functional act 234 of FIG. 2A (e.g., a business credit card account), and then select an action via the operational functional act 241, such as preview history of the selected account by the operational functional act 236 of FIG. 2B. As best illustrated in FIG. 2F, the select account module 234 enables a user to select any one or more specific accounts to perform a variety of tasks on the selected account. As another example, the user may first select an account via the operational functional act 234 of FIG. 2A (e.g., a personal debit card account), and then select an action 241 such as settings modifications by the operational functional act 230 of FIG. 2B for the selected account. As further illustrated, the user may also select an account via the operational functional act 234 of FIG. 2A (e.g., a bank checking account), and then select an action 241 such as starting a transaction by the operational functional act 232 of FIG. 2B using the selected bank checking account. Accordingly, from the main or start screen operational functional act 216 a user may simply select an account via the operational functional act 234 of FIG. 2A, and then select an action 241 in FIG. 2B that the user desires to perform in relation to the selected account.

Alternatively, the user may first select any of the above mentioned specific actions or functions, for example, from the main page or start screen 216, the user may select start of a transaction (operational function act 232 of FIG. 2A), preview of account history (operational functional act 236 of FIG. 2A), or performance of other functions (operational functional act 238 of FIG. 2A), and then optionally select an account via the operational functional act 234 of FIG. 2B to perform the selected function on that selected account.

As indicated above, the settings operational functional act 230 may be accessed via the main screen 216 (FIG. 2A) or, alternatively, after the selection of an account via the operational functional act 234 of FIG. 2A, with the user directed to the settings operational functional act 230 of FIG. 2B (via connector 205 and select action operational functional act 241). Using the settings operational functional act 230 (FIG. 2A or FIG. 2B) to modify WTPS user account settings (via the settings module 230, best illustrated in FIG. 2H) a user may set or modify WTPS user accounting settings in a variety of ways through the WTPS app 190, including (as best illustrated in FIG. 2H) modifying display language and overall layout for the mobile application via the operational functional act 240, associating or reassigning nicknames to various registered accounts such as a bank, credit or debit card account with the WTPS user account via the operational functional act 242. In addition, the operational functional act 242 enables users to prioritize and set as default certain accounts that the user uses the most. Other non-limiting examples of settings may include currency converters that may be set via the operational functional act 244, which convert currency in one denomination (e.g., when using the direct fund transfer of the present invention) to other denominations, if need be. Other settings feature via the operational functional act 246 may include deletion of WTPS app 190 and all related data from Mobile device, or blocking access to an individual account from the mobile device.

As further indicated above, the preview history operational functional act 236 may be accessed via the main screen 216 (FIG. 2A) or, alternatively, after the selection of an account via the operational functional act 234 of FIG. 2A, with the user directed to the preview history operational functional act 236 of FIG. 2B (via connector 205 and select action operational functional act 241). Using the preview history operational functional act 236 to preview account history (preview history module is illustrated in FIG. 2I), a user may view most recent transactions via the operational functional act 250, search and view transactions based on a variety of different search criteria via the operational functional act 252, or perform other functions related to view of account history via the operational functional act 256. For example, operational functional act 256 may be a mode setting operation in which a user may set a mode that WTPS app 190 preview account history in a limited time frame for all transactions (e.g., within the last 30 days only), which would expedite processing of the account history request on the mobile Internet device 108. In general, the account history module (FIG. 2I) may display seller information (e.g., seller name, location, etc.), date of transaction, the amount, or any other information relevant to account history. As with most other accounting GUIs, a user can drill down to view further account details by selecting a specific account, date, or other parameter to view further details of a particular transaction.

As further indicated above, the start transaction operational functional act 232 may be accessed via the main screen 216 (FIG. 2A) or, alternatively, after the selection of an account via the operational functional act 234 of FIG. 2A, with the user directed to the start transaction operational functional act 232 of FIG. 2B (via connector 205 and select action operational functional act 241). The start transaction operational functional act 232 enables a user (e.g., a buyer 106) to commence a desired transaction to purchase, transfer funds, pay bills, or execute other transactional functions. Through the start transaction 232 the consumer can provide disbursement of funds from a desired account (which was associated with the WTPS user account) for the purchase of desired goods and services of a seller 102. As best illustrated in FIG. 2B, the start transaction operational functional act 232 initiates a disbursement protocol 270, enabling the buyer 106 to select (via the operational functional act 272) various interaction protocols, including purchase 274, direct fund transfer 276, bill-payment 278, or other transactional protocols 280. The bill-payment 278 is very similar to known online bill payment systems, with the exception that funds to pay bills are paid through the various personal accounts (e.g., business credit card, bank checking account, etc.) of the user that are associated with the WTPS user account.

As illustrated in FIG. 2B, selection of purchase operational functional act 274 enables the buyer 106 to purchase a product and or service from a seller. Upon selection of the purchase operational functional act 274, the mobile Internet device 108 of the buyer 106 initiates a receive data operational functional act 282 (assuming an account has been selected by the select account 234). FIGS. 2J and 2K are non-limiting examples of implementing the receive data operational functional act 282. FIG. 2J is an exemplary flowchart comprised of operational functional acts that enable reception of data 202 (associated with the seller and seller goods and or services) as an image, and FIG. 2K is an exemplary flowchart comprised of operational functional acts that enable reception of the data 202 (associated with the seller and seller goods and or services) as a wireless signal.

It should be noted that the seller 102 may transmit the data 202 by any means, non-limiting, non-exhaustive listing of examples of which may include data packets and bar codes (e.g., QR codes), or through the seller mobile Internet device, Short Message Service (SMS), Multimedia Message Service (MMS), e-mail, file download, screen shot, etc. Therefore, the examples provided in the flowcharts of FIGS. 2J and 2K should not be limiting. It should further be noted that if the data 202 is transmitted to a mobile Internet device 108, then the buyer 106 must provide the seller 102 with that device's mobile phone number to enable the seller 102 to forward the data 202. Again, no confidential or private information is exchanged and the data 202 transmitted has (at the very least) information that is found in a typical conventional receipt, with the addition of GPS and any other information desired to complete a transaction in accordance with the present invention. For example, for online transactions, the data 202 may also include information that indicates that the transaction is an online transaction.

Referring to FIG. 2J, upon activation of the purchase protocol operational functional act 274, the receive data operational functional act 282 is initiated, which launches the data-image reception protocol 284 to activate an image capturing mechanism 172 such as a camera on the mobile Internet device 108 using the operational functional act 288, and receive a coded-data image via the operational functional act 237. As detailed below, the coded data-image is an image of a machine-readable representation of the data 202 associated with the seller and the desired goods and or services of interest to consumer. In general, each seller 102 (and their goods and or services) is associated with a data 202 that has a machine-readable representation. For online purchases, the generation of the coded-data image may be an online website page in the form of a receipt that includes that coded-data image, such as a typical online confirmation webpage.

Non-limiting, non-exhaustive listing of examples of machine readable coded-data image of data 202 associated with seller 102 and its goods and or services may include well-known barcodes or Quick Response (or QR) codes, an image of which may be printed on a receipt or displayed on a website page and captured by a camera. A QR code is a very well known matrix (or two dimensional) barcode, which is a machine-readable representation of data. Both QR code generator applications and QR code reader applications for wireless devices are also well-known and can easily be downloaded from a vast variety of web sources (mostly free of charge), similar to the manner of downloading a free Portable Document File (PDF) generator and reader. In fact, most mobile Internet devices 108 such as mobile phones may have a QR code reader application pre-installed.

Referring back to FIG. 2J, after receiving the data-image, it is processed by the process coded data image operational functional act 290, which displays the data to validate the seller on the I/O module 160 of the mobile Internet device 108, including all information available with the capture data-image such as purchase amount, date, or any other information found on a conventional receipt. Accordingly, data 202 is a transactional data print out with a QR code printed thereon, which is captured (or photographed) by the mobile Internet device camera 172, with no confidential or private information exchanged between seller and buyer. That is, the QR code or any other code generated by the seller has no confidential or private information.

As indicated above, FIG. 2K is an exemplary flowchart comprised of operational functional acts that enable reception of data 202 as a wireless signal, rather than a coded data-image. As illustrated, upon activation of the purchase protocol operational functional act 274, the receive data operational functional act 282 is initiated, which launches the data reception protocol 286 to activate the transceiver module or to resource mobile messaging system 170 of the mobile Internet device 108 using the operational functional act 292 to wirelessly receive coded-data by the operational functional act 294. The coded-data is a machine-readable representation of data 202 associated with the seller and the desired goods and or services of interest to consumer. As indicated above, the seller may transmit the data 202 by any means.

Non-limiting, non-exhaustive listing of examples of information that may be included in the data 202 associated with the seller 102 are numerous and may include, amongst others, transaction types (e.g., online or offline transaction), seller information such as business name, GPS location of business, physical address of the business, merchant service provider information (if needed), e-commerce information, website address (e.g., domain name for online merchant for online transactions), account information (in relation to the account created when the seller 102 registered to become a member of the WTPS 100), and so on. Other non-limiting, non-exhaustive listing of examples of information that may be included in the data 202 associated with the seller 102 goods or services may include information about an item being sold, including, but not limited to, for example, item (or service) serial number, price, and or any information that is printed on a typical receipt of a transaction when the seller 102 inputs the item information into a typical cash register and prints a conventional receipt or when a purchase is made online and a confirmation page is displayed on a webpage.

Regardless of how the data 202 is transmitted and received, the received data 202 is processed, enabling the data 202 to be displayed by the I/O module 170 of the mobile Internet device 108 in accordance with the operational functional act 298 (FIG. 2C). The data displayed may contain any information desired that is related to the seller 102 and the goods or services being purchased, non-limiting examples of which may include GPS location of the seller 102, or any other additional information, including those found on a conventional receipt, itemized list, prices, taxes, invoice, server, and even table number (e.g., if seller is restaurant), cash register number, etc., or any other information that enables completion of transactions (online or otherwise) in accordance with the present invention, but with no confidential or private information exchanged.

As further illustrated in FIG. 2C, the display of the data via the I/O module 160 by the mobile Internet device 108 in accordance with the operational functional act 298 enables the buyer 106 to confirm the data related to the transaction by the operational functional act 207 and indicated whether the transaction is a deposit (e.g., a security deposit for a rental equipment) or an actual purchase. The buyer 106 may be requested to confirm seller information such as a seller-ID, GPS location, purchase amount, or any other information that enables confirmation of the transaction by the buyer 106. Upon confirmation of data by the operational functional act 207, the confirmed data, and buyer information is transmitted via the operational functional act 209, and received by the WTPS platform 140 by the operational functional act 211. As indicated above, at the confirmation stage 207, the buyer may also select whether the transaction is a mere deposit (such as a security deposit where funds may be verified and authorized, but no actual fund is transacted or transferred to seller) or a normal purchase. This enables a user to use funds from an account associated with the WTPS 100 as mere deposit. For example, this option may be used when renting a product where the seller 102 may require a security deposit. Non-limiting examples of buyer information may include transmitting of buyer GPS location again, and any other relevant information. It is imperative to note that at no time is there any exchange of private or confidential information between a seller 102 and a buyer 106. In other words, no confidential or private information is exchanged between seller 102 and buyer 106. For example, with conventional transactions, a buyer hands out a credit card to a seller, which includes the confidential information such as a credit card number, expiration data, and the name of the cardholder. With the present invention neither the seller 102 nor the buyer 108 exchange any confidential information, and all exchanged information may optionally be encrypted.

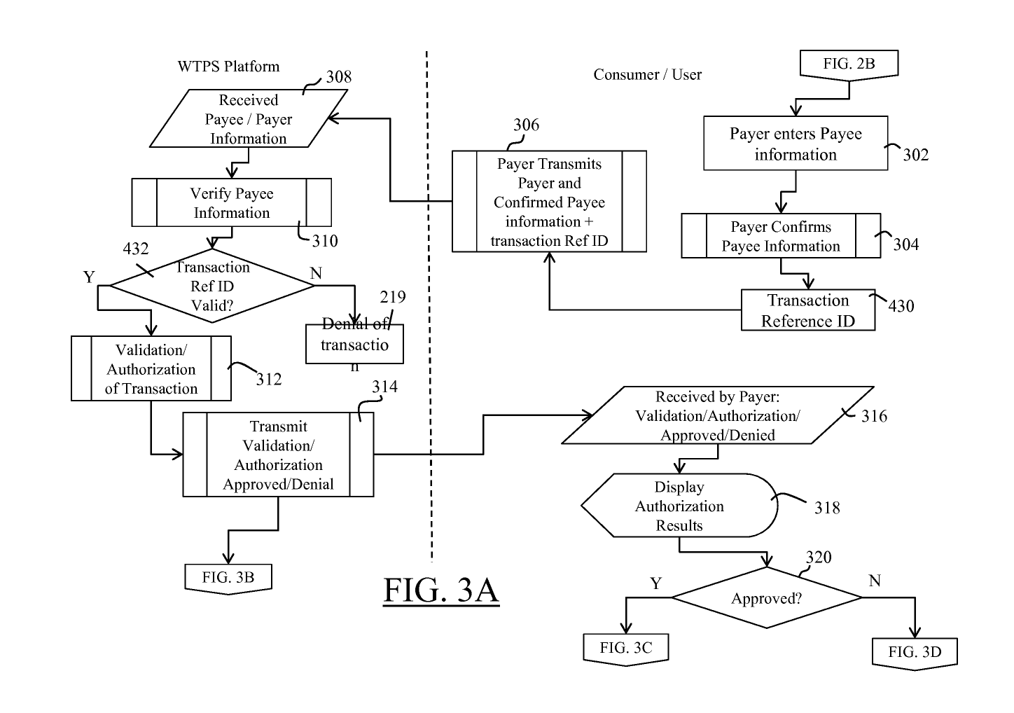

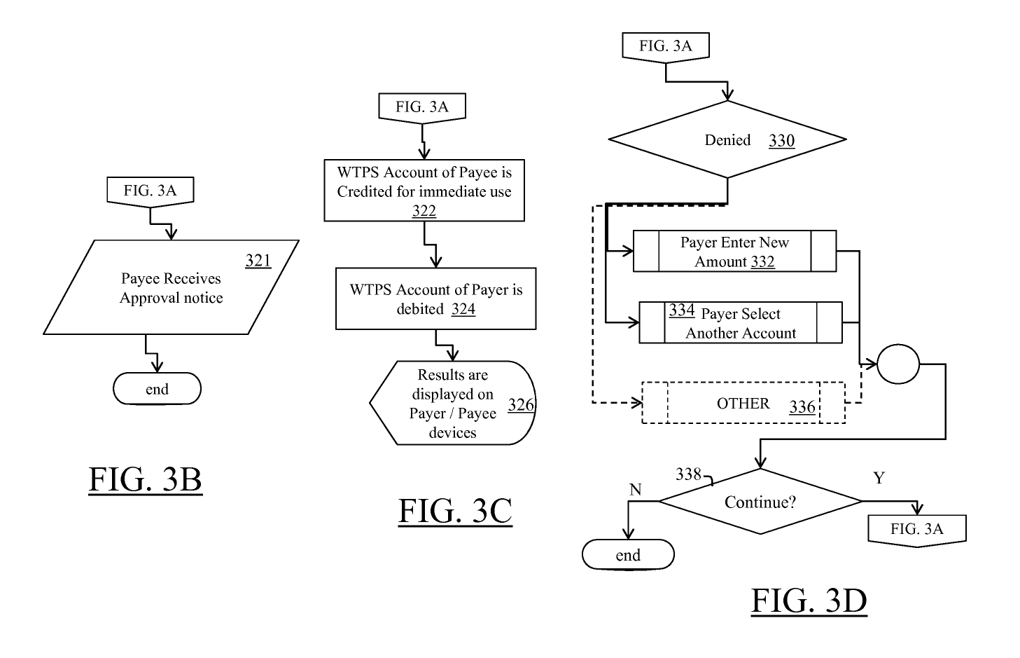

Referring back to FIG. 2C, upon confirmation (at operation 207), at operational functional act 430 a unique reference ID or a tracking identification association with a transaction is generated, this transaction reference ID is generated for every transaction, including those involving mere deposits or just transfer of funds (FIGS. 3A to 3D). The transaction reference ID may be thought of as an in-system (or internal) reference identification used to track and identify any individual transaction, including deposits, purchases, transfers of funds, etc. Therefore, every transaction will have a unique reference transaction identifier, with the reference transaction identifier used (as a reference) to access any transaction that is associated with the reference identifier. It should be noted that the reference ID generated is not global (in relation to the entire WTPS), but is generated uniquely for the particular mobile Internet device 108 of a user, and may be generated by a wide variety of different types of algorithms. As a non-limiting example, the reference identifier for a transaction may be a simple sequential number that is generated within and for the particular mobile Internet device 108 every time the user makes a transaction (purchase, transfer of funds, deposit, or any other), which may also include the user mobile number.

As stated above, upon confirmation of data by the operational functional act 207, and generation of the transaction reference ID at the operational functional act 430, the confirmed data, reference ID, and buyer information is transmitted via the operational functional act 209, and received by the WTPS platform 140 by the operational functional act 211. The received data, reference ID, and buyer information by the WTPS platform 140 via the operational functional act 211 is then processed by the operational functional acts 213 and 215. The process at 213 may include simply verifying the data 202 transmitted by the seller 102. In this embodiment, it may also include verifying that the seller 102 is a legitimate member of the WTPS system 100 by checking the instant received information at operational functional act 211 against stored registration information of the seller 102, similar to the manner illustrated in FIG. 2L where the buyer 106 is verified.

The operational functional act 215 determines the seller location and mobile location of the buyer. Upon the determinations at the operational functional acts 213 and 215, at the operational functional act 432, the WTPS determines if the transaction reference ID is valid. The validity of the transaction reference ID may be determined by a variety of methods, which may depend upon the algorithm used to generate the reference IDs. As a non-limiting example, if the transaction reference ID is generated as a sequential number, and the WTPS platform determines that the transaction reference ID is out of sequence, then the entire transaction is simply denied, and the WTPS user account holder is notified. This scenario is likely if the original mobile Internet device has been cloned. For example, the WTPS of the original mobile device may have generated transaction reference ID with a sequence number 0005 for a particular transaction, with the next subsequent number to be 0006. As stated above, the transaction reference ID is a unique identifier associated with and generated by the WTPS app 190 of the particular mobile Internet device. Therefore, the cloned mobile Internet device will commence its transaction reference ID at a number (or other identifier) when the original phone was cloned, which may have been at sequence number 0003. In such an exemplary instance, the sequence of the transaction reference ID for the original mobile Internet device is at 0006, but the WTPS app of the cloned mobile Internet device will generate the transaction reference ID starting at the sequence 0004 (which has already been used once by the original mobile Internet device). This is similar to two individuals writing checks from the same account, but the check number sequences do not match. The user of the original checks is on check number 0110, with check numbers 0100 to 0109 already cleared, and the other user using copied checks that start with copied check number 0107 writes a check with check number 0107 or 0108.

To continue with FIG. 2C, upon validation of the transaction reference ID at the operational functional act 432, the operational functional act 217, WTPS system 100 determines if buyer 106 is in the same physical location as the seller 102. If buyer 106 and the seller 102 are not in the same location, then at the operational functional act 702, WTPS 100 determines if the transaction is an online transaction (via the information from the data 202 or input by the buyer 106). If the transaction is not an online transaction, then the authorization for the transaction is denied at the operational functional act 219, and a denial of service is transmitted to the buyer 106 via the operational functional act 221, where it is received by the operational functional act 223 of the WTPS app 190, and displayed by the I/O module 160 of the mobile Internet device 108 of the buyer 106. The use of GPS or similar location identifier systems to access and use the WTPS 100 of the present invention is intended to verify that the consumer was at a particular location for purchase of goods and services from a seller.

As further indicated in the operational functional act 217, if WTPS system 100 determines that the buyer 106 is in the same physical location as the seller 102 or that the transaction is an online transaction (operational functional act 702), then at the operational functional act 704 the WTPS system 100 commences validation protocol 704. That is, all verified information is processed and validated by the operational functional act 704. Thereafter, at the operational functional act 225, the WTPS 100 commences authorization of the transaction. In other words, as indicated by the flowchart of FIG. 2C, WTPS 100 may both verify users (buyers, sellers, and so on) 704 and authorize transaction or credit approval/denial 225 without any third party 227.

It should be noted that the authorization protocol may be accomplished by a third party processor 227, such as a bank or any other convention entity that processes credit, debit, or bank transactions. That is, information (such as buyer ID, buyer location information, and data 202) that is to be verified may be verified by the operational functional act 704 of the WTPS 100 as illustrated, and a third party 227 executes authorization of transaction (or credit approval/denial) once verification by WTPS 100 has been completed. The authorization of the transaction by the third party 227 is then received by WTPS 100 through the operational fictional act 229, and transmitted via the operational functional act 221.

Non-limiting examples of verification and then authorization may include verifying availability of funds in the selected account of the buyer for the selected transactions, limits or restrictions placed on the buyer account, or any other information that would cause termination or approval of the purchase, similar to the conventional manner that a credit card account of a buyer is verified and then authorized (e.g., approved or denied) for a particular transaction.

FIG. 2D is an exemplary flowchart that illustrated the receiving of verification and authorization by the seller and FIG. 2E is an exemplary flowchart that illustrated the receiving of verification and authorization by the buyer. As illustrated in FIG. 2D, the seller receives all information, including an optional previously uploaded portrait of the buyer at the operational functional act 233, and processes that information at the operational functional act 235. The portrait would function as a photo ID in a similar manner as those found printed on major credit cards. Accordingly, the seller would not only receive approval or denial of the transaction, but also a portrait of the buyer (as a safeguard). Therefore, even if the transaction is approved, if the portrait is a photo of an individual who is not the actual buyer, the seller would simple terminate transaction. With respect to FIG. 2E, the buyer receives the validation, and merely discloses that information to the seller, where at the operational functional act 237, the seller receives that information from the buyer. Regardless of the entity that executes the authorization protocol, the WTPS platform 140 may transmit the authorization to both the buyer 106 and seller 102. It should be noted that if the transaction type is mere deposit indicated in the operational functional act 207 (e.g., security deposit for rental of equipment), then all funds may be “authorized” with no actual transfer of funds.

FIGS. 3A to 3D are exemplary flowcharts illustrating a process of transfer of funds from one individual or entity to another individual or entity using the wireless transaction processing system in accordance with the present invention. The selection of direct transfer operational functional act 276 (illustrated in FIGS. 2A and 2B) enables a first member (e.g., payee) of the WTPS 100 with a mobile Internet device 108 to request direct transfer of funds from a second member (e.g., payer) of the WTPS 100 that also has a mobile Internet device 108.

As illustrated, the second member (e.g., payer) accesses the wireless transaction processing system by the mobile Internet device 108 as described above in relation to FIGS. 2A to 2L, and is directed to the direct transfer operational functional act 276, and selects the desired account from which the second member (e.g., payer) is to provide a disbursement for the direct transfer of funds to the first user (e.g., payee). As best illustrated in FIG. 3A, the selection of the direct transfer operational functional act 276 initiates a GUI at the operational functional act 302 that would enable the second member (e.g., payer) to enter the destination of the funds to be transferred. That is, the second member enters the first member information, including the amount of transfer of funds in the operational functional act 302, and confirms the entered data or information at the operational functional act 304, where upon confirmation, a transaction reference ID 430 is generated by the WTPS app 190, with all information transmitted to the WTPS platform 140. That is, the WTPS app 190 of the mobile Internet device 108 transmits both the payer information and confirmed payee information, including the reference ID 430 to the WTPS platform 140 via the operational functional act 306. The function and use of the transaction reference ID 430 is detailed above in relation to FIG. 2C.

As further illustrated, the WTPS 140 received the transmitted information at the operational functional act 308, with WTPS 100 verifying first member (e.g., payee) information at the operational functional act 310, including checking the transaction reference ID. If transaction reference ID is not valid, the entire procedure is denied and the process terminated at the operational functional act 219, otherwise, the WTPS 100 further executes validation and authorization protocols for the transaction (assuming the transaction reference ID is valid) at the operational functional act 312, and transmits results via the operational functional act 314 to second member (e.g., payer) and the first member (e.g., payee). As further illustrated, the second member (e.g., payer) receives the validation and authorization at the operational functional act 316, where WTPS app 190 displays the results to the second member via the operational functional act 318.

As illustrated in FIG. 3B, the payee (first member) receives approval (if any) results at the operational functional act 321. If at the operational functional act 320 (FIG. 3A) the direct transfer of fund is approved (validated and authorized), the WTPS 100 credits the payee (the first member) selected account at the operational functional act 322 (FIG. 3C), and WTPS 100 debits the payer (second member) selected account at the operational functional act 324, and displays the respective results for respective payer and payee at the operational functional act 326. That is, the payee (first member) views that the selected account of the first member has been credited by the transfer amount, and the payer (second member) views that the selected account of the second member has been debited by the transfer amount.

Referring back to FIG. 3A, if the authorization results in denial (not approved) in the operational functional acts 320, then as illustrated in FIG. 3C, several choices is presented to the payer (the second member). That is, if transfer is denied (operational functional act 330), payer may enter a new amount (at the operational functional act 332), select another account from which to transfer funds at the operational functional act 334, or perform other functions such as reschedule the same transfer to a later date at the operational functional act 336 (where funds may be available at some future date). The second member (e.g., payer) may then select to continue at the operational functional act 338 or terminate the entire process. Accordingly, as with purchasing a product, no private or confidential information is exchanged during the fund transfer.

As has been described above, the WTPS 100 is a separate entity that functions as a “hub” between consumers (buyers 106 and sellers 102), credit issuing entities 103, card networks 105, and the optional third party processors 227 for processing cashless transactions. As described below, the present invention provides another embodiment wherein the WTPS 100 is fully integrated with an existing credit issuing entity and or a third party processor, rather than functioning as a standalone platform.

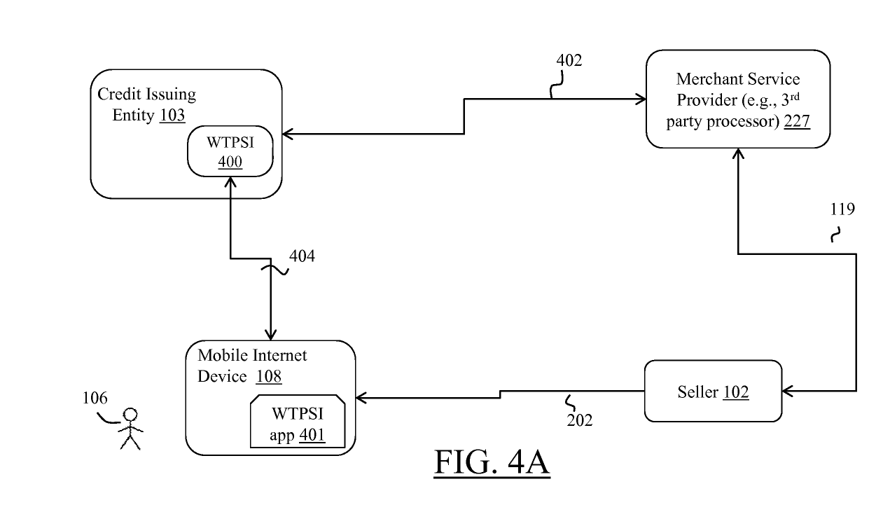

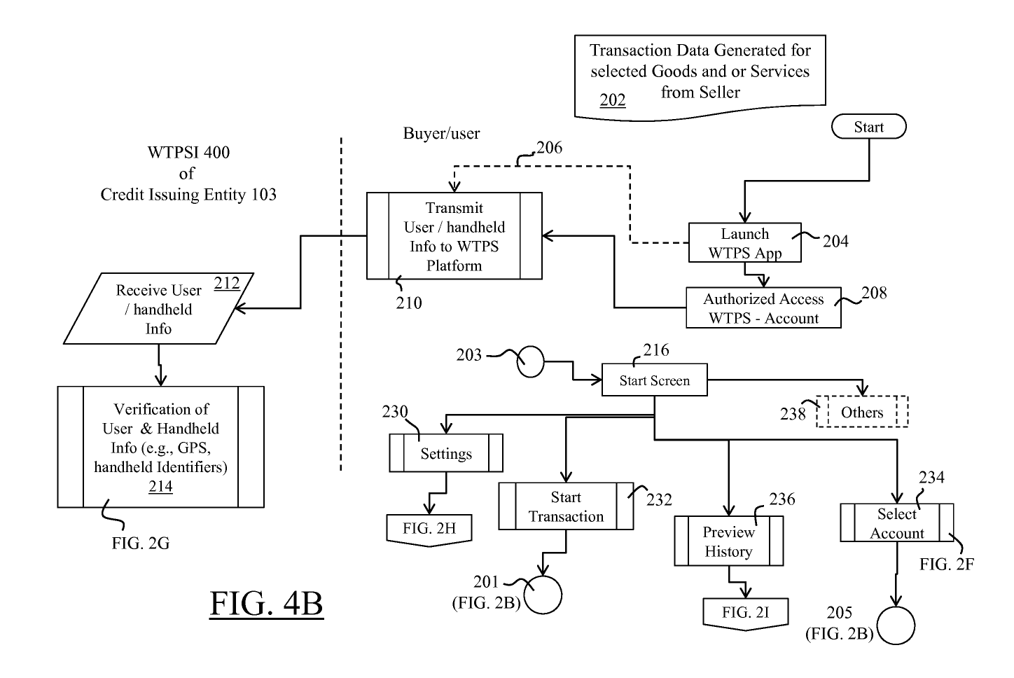

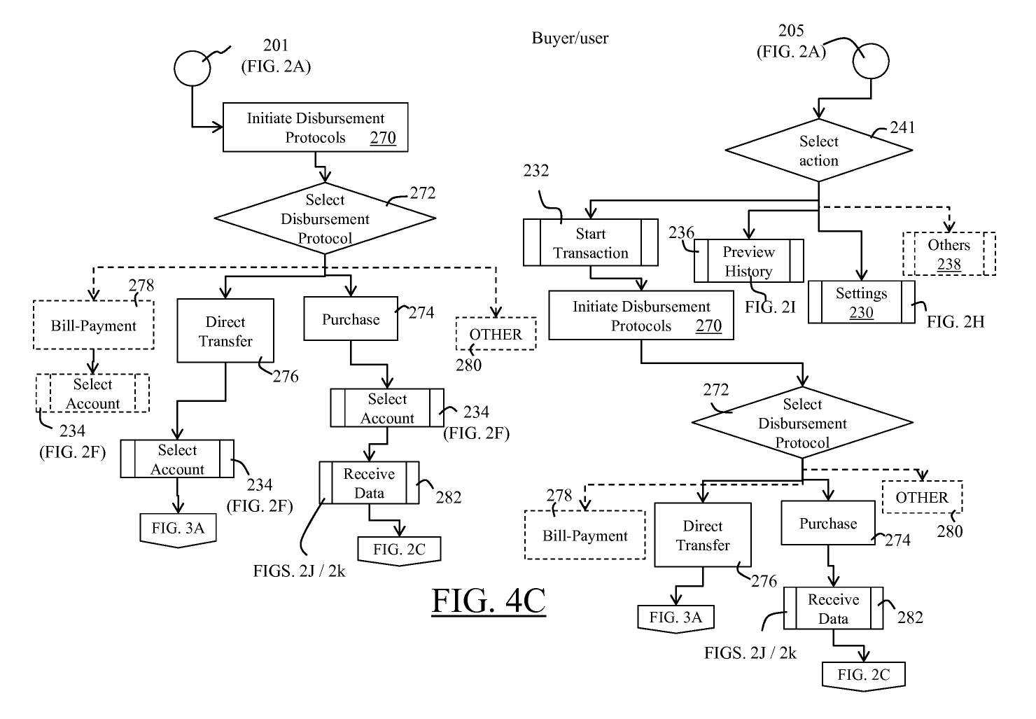

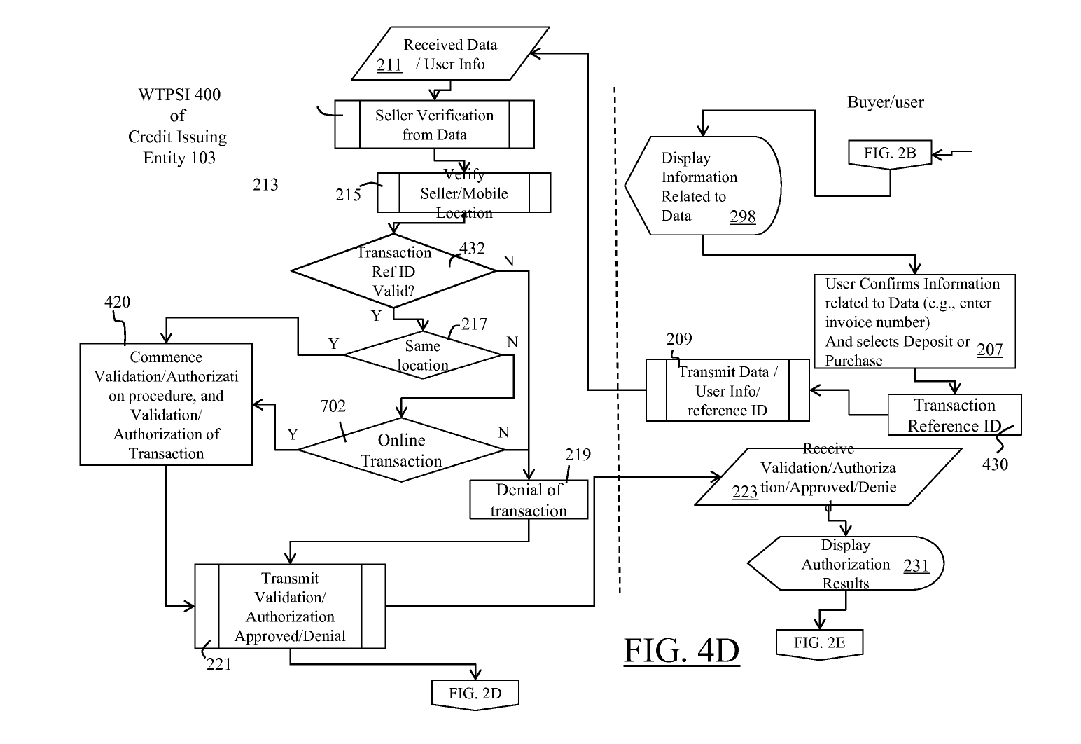

FIG. 4A is an exemplary system overview of the wireless transaction processing system of the present invention integrated within an existing credit/debit issuing entity in accordance with the present invention. The integration of WTPS Integrated (hereinafter referred to as “WTPSI”) 400 into existing credit issuing entity 103 enables for a more direct transaction processing, and reduces time for validation and authorization of transactions. The WTPSI 400 can also allow credit organizations to provide their own payment network instead of relying on existing credit/debit card networks 105, which eliminates fees associated with the existing credit/debit card networks 105.

As illustrated in FIG. 4A, the WTPSI 400 is integrated within a credit issuing entity 103 such as a bank that issues credit. For each credit issuing entity 103, the buyer 106 would have to have a separately branded and associated version of WTPSI mobile application 401. This is similar to buyers 106 having separately branded cards associated with each different credit issuing entity 103. Additionally, each credit issuing entity 103 includes a version of WTPSI 400 that may be self-branded for their use. Accordingly, when a buyer opens an account (e.g., a savings, checking, credit/debit, line of credit, etc.) with a credit issuing entity 103, their account would have access to WTPSI 400 of that credit issuing entity 103. Upon establishment of an account with the credit issuing entity 103, that account is associated with the WTPSI 400 and the buyer 106 is automatically offered access to the branded WTPSI mobile application 401 of the credit issuing entity 103. Following instructions provided by the credit issuing entity 103, the WTPSI mobile application 401 is downloaded to the mobile Internet device 108 (such as a mobile phone) of the buyer 106, enabling access to buyer account associated with WTPSI 400. Thereafter, the downloaded the WTPSI app 401 may be launched via the mobile Internet device 108 to enable a user (e.g., buyer 106) access to the WTPSI 400 enabled features of their credit issuing entity 103 user account to execute various transactions or functionalities. In other words, the account provided by the credit issuing entity 103 can be accessed via the WTPSI mobile app 401 by buyer 106 and used as if using a “credit card,” “debit card,” or “line of credit” to purchase, place a deposit, transfer funds, etc. without using any physical cards. Further, since the established user account being used for the transaction is provided and managed directly by the credit issuing entity 103 and available via the mobile app 401 of the WTPSI 400 to buyer 106, there is no need for a credit network 105. In other words, as information regarding account balance and the availability of funds is directly managed by the credit issuing entity 103 and provided via the WTPSI 400 for authorization at the point of transaction, there is no need for the credit network 105 (which functions to provide that information).

As illustrated in FIG. 4A, the buyer 106 may select the desired items from the exemplary convenience store or seller 102 for purchase (e.g., a bag of groceries), with the seller 102 generating a transaction data 202 for the buyer 106 for the selected goods and or services. The transaction data 202 includes all required information mentioned above in relation to FIGS. 1A to 3D that identifies the items purchased and pricing, and the merchant or seller 102 information, non-limiting, non-exhaustive listing of which may further include merchant name, address, phone, GPS information, merchant terminal identifier (e.g., credit card reader), merchant account provider and number (e.g., merchant bank name, merchant bank ID, merchant account ID, or any other non-confidential information that would enable the credit issuing entity 103 to communicate with and or transfer (or credit) funds to the merchant bank associated with seller 102, etc.). As was stated above, a non-limiting example of a third party processor 227 may be a merchant bank that functions as a merchant service provider (e.g., providing a merchant account to seller 102 for enabling the seller 102 to accept card-based types transactions). Accordingly, the transaction data 202 must include sufficient (non-confidential) information about the seller (and merchant service provider) so to enable transfer or crediting of funds for the purchase of items by the buyer 106.

When a buyer 106 makes a purchase from the seller 102 using the mobile Internet device 108, transaction data 202, including buyer 106 information (e.g., GPS location, etc. as shown and described above in relations to FIGS. 2A to 2L) is communicated via 404 to the WTPSI 400 of the credit issuing entity 103. The credit issuing entity 103 receives the transaction information via 404, confirms it, and if the buyer has sufficient credit for payment of the transaction, then the credit issuing entity 103 issues an approval to the merchant bank (or third party processor 227), which, in turn, communicates via 119 the results (approval/denial) with the seller 102. After the transaction is complete, the account of the buyer 106 is debited by the purchase amount and the account of the seller 102 (e.g., seller merchant account) is credited by the same amount, and the respective accounts of the buyer 106 and seller 102 are updated in all entities involved in the transaction. The information exchange between the third party processor 227 (or merchant bank) and seller 102 (via 119) is well-known. Accordingly, with the WTPSI 400, a buyer 106 uses the mobile Internet device WTPSI app 401 of the WTPSI 400 to access the user established bank account to commence and complete a transaction without the buyer 106 using a credit card or the credit issuing bank 103 using the credit cards network 105.

It should be noted that with this embodiment, a seller 102 need not bank with the credit issuing entity and therefore, need not have any account associated (or registered) with the WTPSI 400. Additionally, the integration of WTPSI 400 with the issuing entity 103 would enable the issuing entity 103 to instantaneously be cognizant of the available balance and credit amount for each user 106 without using the credit/debit card network 105 since all transactions for buyer 106 are through the buyer account associated with WTPSI 400 of the credit issuing entity 103. In other words, the credit issuing entity 103 no longer needs to communicate with the credit/debit card network 105 to determine the availability of funds and total amount credited to the consumer since the account of the buyer with the credit issuing entity 103. This eliminates the dependents or the need for the credit/debit card network 105, which speeds up the transactions, and lowers overall transaction costs.

FIGS. 4B to 4D are exemplary detailed flowchart illustrations of the details of the contactless wireless transaction processing system of FIG. 4A in accordance with the present invention. The WTSPI 400 details shown in FIGS. 4B to 4D includes similar corresponding or equivalent components, interconnections, and or cooperative relationships and functions as the WTPS 100 that is shown in FIGS. 1A to 3D, and described above. Therefore, for the sake of brevity, clarity, convenience, and to avoid duplication, the general description of WTPSI 400, and those shown in FIGS. 4A to 4D will not repeat every corresponding or equivalent component and or interconnections or functions that has already been described above in relation to WTPS 100 detailed in FIGS. 1A to 3D.

As stated above, with the WTPSI 400 the seller 102 need not be a registered member and therefore, only the buyer 106 is required to have an account with a credit issuing entity 103 that includes an integrated WTPSI 400. The account setup and the registration requirements and methods and online access to features of WTPSI 400 associated with the buyer account may be governed by the credit issuing entity 103 within which the WTPSI 400 is integrated.

As best illustrated in FIG. 4B, the details shown and described for various entities in FIG. 2A apply to the WTPSI 400 with the exception that instead of using WTPS 100 or WTPS app 190, it is the WTPSI 400 integrated within the credit issuing entity 103 and the associated WTPSI app 401 that is used. Accordingly, the above description with respect to FIG. 2A applies to FIG. 4B, with the reader substituting the instances of WTPS 100 with WTPSI 400, and WTPS 190 with WTPSI 401.

As illustrated in FIG. 4C, the details shown and described for various entities in FIG. 2B apply to FIG. 4C with the first exception that (as with FIG. 4B) the WTPSI 400 and WTPSI app 401 are used instead of WTPS 100 and WTPS app 190, and the additional exception that the operational functional act bill-payment 278 may be optional and may be implemented by the credit issuing bank 103, rather than be a part of WTPSI 400.

As illustrated in FIG. 4D, the details shown and described for various entities in FIG. 2C apply to FIG. 4D with the following exceptions. As with FIGS. 4B and 4C, with FIG. 4D, the WTPSI 400 and WTPSI app 401 are used instead of WTPS 100 and WTPS app 190. Further, the operational functional act 420, which is the start of validation/authorization procedure and validation/authorization of transaction, is executed by the credit issuing entity 103 within which the WTPSI 400 is integrated, rather than by WTPS 100 and or a third party 227. In particular, if the WTPSI 400 of the credit issuing bank 103 determines that the seller 102 and buyer 106 are in the same location (operational functional act 217) or the transaction is an online purchase (operational functional act 702), then the credit issuing bank 103 executes operational functional act 420.

The description and the illustration in FIGS. 3A to 3D for WTPS 100 and WTPS app 190 apply to the WTPSI 400 and WTPSI 401 with the exception that WTPS 100 and WTPS app 190 are substituted with the WTPSI 400 and WTPSI 401.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

In addition, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of,” “act of,” “operation of,” or “operational act of” in the claims herein is not intended to invoke the provisions of 35 U.S.C. 112, Paragraph 6.

1. A contactless wireless transaction processing system, comprising:
servers that provide a hub for communications and cashless transactions between diverse entities;
a third party processor server;
at least one buyer account and a buyer mobile Internet device selected and associated with the contactless wireless transaction processing system;
a transaction data generated for a selected goods or services associated with a registered seller account, with the transaction data having no information considered confidential;
the buyer mobile Internet device receives the transaction data, and upon confirmation, a transaction reference ID is dynamically generated by both the mobile Internet device and the contactless wireless transaction processing system platform, with the transaction reference ID associated with a transaction;
the buyer mobile Internet device transmits the transaction data with the transaction reference ID and GPS information of the buyer mobile Internet device and location to the contactless wireless transaction processing system for validation of buyer account and location, a seller account and the seller location, transaction reference ID, and transaction data;
with the third party process server authorizing the transaction after validation by the contactless wireless transaction processing system; and
with the seller account credited and the buyer account debited in accordance with the transaction data.

2. A transaction system, comprising:
an integrated contactless wireless transaction processing system that is integrated with a credit issuing entity;
at least one buyer account and a buyer mobile Internet device selected and associated with the integrated contactless wireless transaction processing system of the credit issuing entity;
a transaction data generated for a selected goods or services associated with a registered seller account during a purchase transaction, with the transaction data having no information considered confidential;
the buyer mobile Internet device receives the transaction data, and upon confirmation, a transaction reference ID is dynamically generated by both the buyer mobile Internet device and the contactless wireless transaction processing system platform, with the transaction reference ID associated with a transaction;
the buyer mobile internet device transmits the transaction data with the transaction reference ID and GPS information of the buyer mobile Internet device and location to the integrated contactless wireless transaction processing system of the credit issuing entity for validation of buyer account and location, seller account and location, the transaction reference ID, and transaction data;
with the credit issuing entity authorizing the transaction after validation by the integrated contactless wireless transaction processing system of the credit issuing entity;
wherein the authorization is communicated with a merchant service provider of seller account, with the seller account credited and the buyer account debited in accordance with the transaction data.

3. The transaction system as set forth in claim 2, wherein:
the association of the account with the integrated contactless wireless transaction processing system of the credit issuing entity commences when the account is established with the credit issuing entity.

4. The transaction system as set forth in claim 3, wherein:
after the association, a branded integrated contactless wireless transaction processing system of the credit issuing entity is downloaded as a branded mobile application to the mobile Internet device, enabling the mobile Internet device to communicate and access the associated account.

5. A computer program product for wireless transaction processing system for purchasing, the computer program product comprising a computer-readable medium having computer program instructions stored therein for causing one or more computers to perform operations of:
receiving a transaction data associated with a registered seller account, and upon confirmation, generating a transaction reference ID associated with a transaction;
transmitting the transaction data and the transaction reference ID with GPS information of a buyer account to an integrated contactless wireless transaction processing system of a credit issuing entity;
validating buyer account and location, seller account and location, transaction reference ID, and transaction data;
the credit issuing entity authorizing the transaction after validation by the integrated contactless wireless transaction processing system of the credit issuing entity;
communicating authorization with a merchant service provider of the seller account, with the seller account credited and the buyer account debited in accordance with the transaction data.

6. A direct fund transfer system, comprising:
a payee account and payee Internet enabled handheld device associated with a wireless transaction processing system;
a payer account and payer Internet enabled handheld device associated with a wireless transaction processing system;
payee identification information is internally retrieved by the payer Internet enabled handheld device or manual entered into the payer Internet enabled handheld device and upon confirmation, a transaction reference ID is dynamically generated by both the payer mobile Internet device and the wireless transaction processing system, with the transaction reference ID associated with a transaction;
the payer mobile Internet device transmits the transaction data with the transaction reference ID to the wireless transaction processing system for validation of payer account, payee account, and transaction reference ID and upon validation authorizes transfer of funds, crediting the payee account associated with the wireless transaction processing system and debiting the payer account associated with the wireless transaction processing system, with funds immediately available in payee account.
